(19) United States
(12) Patent Application Publication
(10) Pub. No.: US 2025/0004133 A1
(43) Pub. Date: Jan. 2, 2025

(54) METROLOGY SYSTEM INCLUDING LASER AND RADAR CONFIGURATION

(71) Applicant: Mitutoyo Corporation, Kanagawa-ken (JP)

(72) Inventors: Ted Staton COOK, Kirkland, WA (US); Nick HARTMANN, Kirkland, WA (US)

(21) Appl. No.: 18/344,731

(22) Filed: Jun. 29, 2023

(51) Int. Cl. G01S 17/42; G01S 7/481; G02B 5/12

(52) U.S. Cl. CPC G01S 17/42; G01S 7/481; G02B 5/12

(57) ABSTRACT

A metrology system is provided including a laser and radar configuration and a retroreflector portion. A main body portion of the laser and radar configuration includes a laser portion and a radar portion, which transmit laser light and radar signals. A rotator portion rotates the main body portion to change a transmission direction of the laser light and the radar signals (e.g., as partially controlled based on operations of an optical sensor of the laser portion) to be directed toward the retroreflector portion. The radar portion receives the reflected radar signals (e.g., which enable a distance to the retroreflector portion to be determined). 3-dimensional positions of the retroreflector portion (e.g., as disposed at an object to be measured) are determined based at least in part on angular positions determined from operations of the laser portion and distances determined from operations of the radar portion.

### BACKGROUND

### Technical Field

This disclosure relates to metrology and, more particularly, to a metrology system utilizing a laser and radar configuration.

### Description of the Related Art

A tracking-type laser interferometer may be used as an apparatus for measuring a distance to a movable body (e.g., as attached to an object to be measured). An example of a tracking-type laser interferometer is disclosed in U.S. Pat. No. 7,872,733, which is hereby incorporated herein by reference in its entirety. The '733 patent describes a system in which the tracking type laser interferometer detects displacement of a retroreflector (e.g., as coupled to an object to be measured) by utilizing interference of a laser beam irradiated onto the retroreflector and reflected by the retroreflector in a returning direction (e.g., which is parallel with a sending direction). More specifically, the interferometer utilizes the interference light to determine the distance to the retroreflector. In addition to measuring the distance, the system performs angular tracking by means of a two-axis turning mechanism using displacement in the position of the optical axis of the laser beam (e.g., utilizing a position sensitive detector).

In certain prior tracking-type laser interferometer systems, the components utilized for determining the distance to the retroreflector may be relatively complex, expensive and/or have limited accuracy. A metrology system with improved characteristics would be desirable.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A metrology system is provided which includes a laser and radar configuration and a retroreflector portion which comprises a retroreflector. The retroreflector portion is configured to receive and reflect transmitted laser light (e.g., as transmitted from a laser portion of the laser and radar configuration) and to receive and reflect transmitted radar signals (e.g., as transmitted from a radar portion of the laser and radar configuration). A main body portion of the laser and radar configuration includes the laser portion and the radar portion. The laser portion comprises a laser and an optical sensor. The laser is configured to transmit the laser light that is reflected by the retroreflector portion. The optical sensor is configured to receive the reflected laser light and to detect positional changes of an optical axis of the reflected laser light which occur as a result of positional changes of the retroreflector portion. The radar portion is configured to transmit the radar signals that are reflected by the retroreflector portion, and receive the reflected radar signals (e.g., which enable a distance to the retroreflector portion to be determined). The rotator portion is configured to rotate the main body portion to change a transmission direction of the laser light and the radar signals (e.g., to be directed toward the retroreflector portion, and as controlled based at least in part on the output of the optical sensor). The rotator portion (e.g., including a biaxial rotation mechanism portion) comprises an angle sensor portion configured to sense one or more rotation angles of the rotator portion.

In various implementations, the metrology system may further include one or more processors and a memory coupled to the one or more processors and storing program instructions that when executed by the one or more processors cause the one or more processors to at least: determine a first angular position of the retroreflector portion based at least in part on the determined one or more rotation angles of the rotator portion; determine a first distance to the retroreflector portion based at least in part on the reflected radar signals; and determine a first 3-dimensional position corresponding to a position of the retroreflector portion based at least in part on the determined angular position of the retroreflector portion and the determined distance to the retroreflector portion. In various implementations, the determined first 3-dimensional position may correspond to a first part or position of an object to be measured which the retroreflector portion is disposed at.

In various implementations, after the retroreflector portion is moved to be disposed at a second part or position of an object to be measured, the program instructions when executed by the one or more processors may further cause the one or more processors to: determine a second angular position of the retroreflector portion based at least in part on determined one or more rotation angles of the rotator portion; determine a second distance to the retroreflector portion based at least in part on reflected radar signals; and determine a second 3-dimensional position corresponding to a position of the retroreflector portion based at least in part on the determined second angular position of the retroreflector portion and the determined second distance to the retroreflector portion. The program instructions when executed by the one or more processors may further cause the one or more processors to determine a dimension of the object to be measured based at least in part on a distance between the determined first 3-dimensional position and the determined second 3-dimensional position.

In various implementations, a method for operating the metrology system is provided. The method may include: determining a first angular position of the retroreflector portion based at least in part on the determined one or more rotation angles of the rotator portion; determining a first distance to the retroreflector portion based at least in part on the reflected radar signals; and determining a first 3-dimensional position corresponding to a position of the retroreflector portion based at least in part on the determined angular position of the retroreflector portion and the determined distance to the retroreflector portion.

In various implementations, a laser and radar configuration is provided for use with a retroreflector portion comprising a retroreflector as part of a metrology system. The laser and radar configuration comprises the main body portion and the rotator portion. The main body portion comprises the laser portion and the radar portion. The rotator portion is configured to rotate the main body portion to change a transmission direction of the laser light and the radar signals (e.g., to be directed toward the retroreflector portion).

### BRIEF DESCRIPTION OF THE DRAWINGS

FIGS. 1A and 1B are diagrams illustrating a side view and a top view of a metrology system including a laser and radar configuration with a main body portion, a rotator portion and a control system portion.

FIGS. 2A and 2B are diagrams illustrating a side view and a top view of a main body portion including a laser portion and a radar portion and including reflective surfaces for directing laser light from the laser portion to be parallel or coaxial with radar signals from the radar portion.

FIG. 3 is a diagram illustrating a side view of a main body portion similar to that of FIGS. 2A and 2B except not including the reflective surfaces.

FIG. 4 is a diagram illustrating a side view of a main body portion including a laser portion with additional features and a radar portion and including reflective surfaces for directing laser light from the laser portion to be parallel or coaxial with radar signals from the radar portion.

FIG. 5 is a diagram illustrating a side view of a main body portion similar to that of FIG. 4 except not including the reflective surfaces.

FIG. 6 is a diagram illustrating a side view of a main body portion similar to that of FIG. 5 except with the radar portion oriented at an angle relative to the laser portion.

FIG. 7 is a flow diagram illustrating one exemplary implementation of a routine for operating a metrology system including features as disclosed herein.

### DETAILED DESCRIPTION

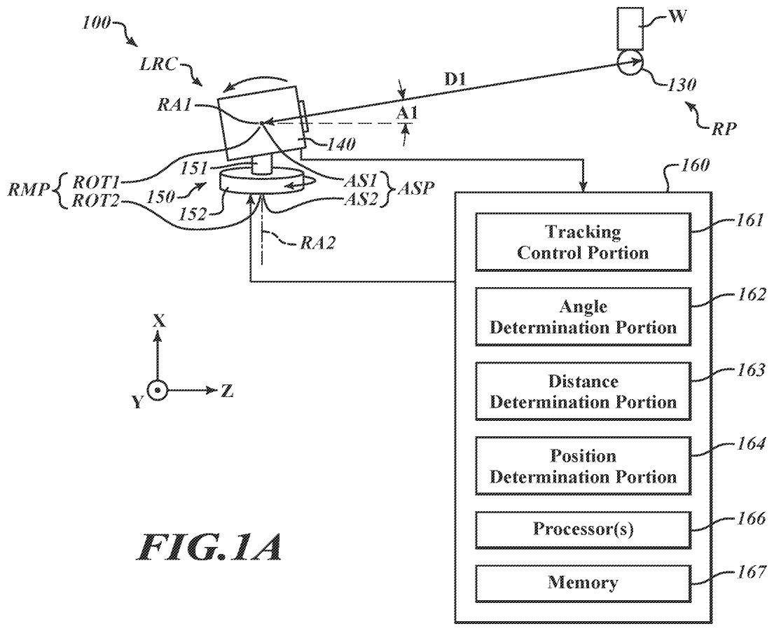

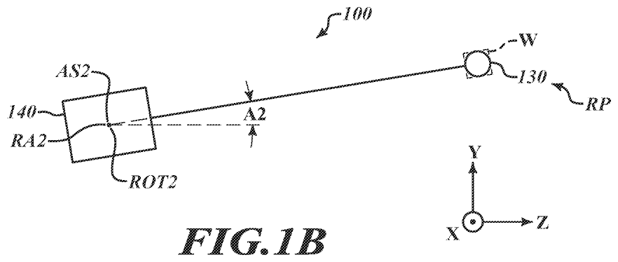

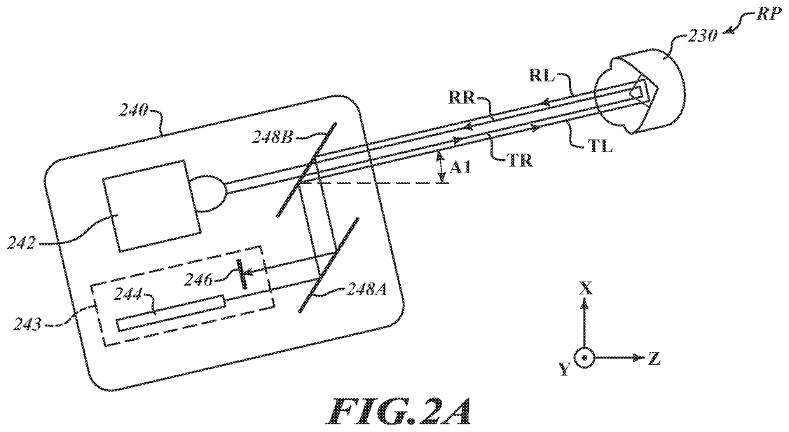

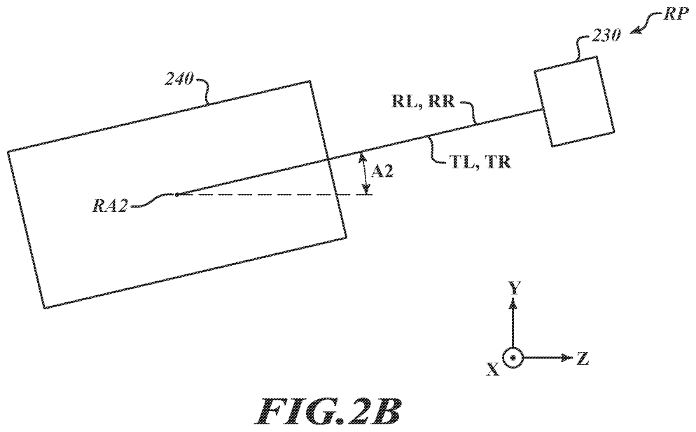

FIGS. 1A and 1B are diagrams illustrating a side view and a top view, respectively, of a metrology system 100. As illustrated in FIGS. 1A and 1B, the metrology system 100 includes a laser and radar configuration LRC with a main body portion 140 which directs laser light and radar signals toward a retroreflector portion RP which comprises a retroreflector 130. As will be described in more detail below, the operations of the laser and radar configuration LRC enable an angular position and a distance of the retroreflector portion RP to be determined, which correspondingly enable a determination of a 3-dimensional position (e.g., including X, Y, Z or other coordinates of a designated 3-dimensional coordinate system) of the retroreflector portion RP. More specifically, as will be described in more detail below (e.g., with respect to FIGS. 2A-7), an angular position (e.g., as indicated by angles A1 and A2 in FIGS. 1A and 1B, respectively) of the retroreflector portion RP may be determined based at least in part on the operations of a laser portion (i.e., as part of the main body portion 140) which transmits laser light to the retroreflector portion RP and receives reflected laser light from the retroreflector portion RP. A distance (e.g., as indicated by the distance D1 of FIG. 1A) of the retroreflector portion RP may be determined based at least in part on the operations of a radar portion (i.e., as part of the main body portion 140) which transmits radar signals to the retroreflector portion RP and receives reflected radar signals from the retroreflector portion RP.

In various implementations, the laser and radar configuration LRC further includes a rotator portion 150 and a control system portion 160. The rotator portion 150 (e.g., as controlled by a tracking control portion 161 of the control system portion 160) is configured to rotate the main body portion140 to change a transmission direction of the laser light and the radar signals (e.g., to be directed toward the retroreflector portion RP). The rotator portion 150 comprises a support member 151, a base member 152, a rotation mechanism portion RMP and an angle sensor portion ASP. The rotation mechanism portion RMP (e.g., comprising rotation mechanisms ROT1 and ROT2) has two rotation axes RA1 and RA2 and is configured to independently rotate along the two axes to change the transmission direction of the laser light and the radar signals. In various implementations, the rotation mechanisms ROT1 and ROT2 (e.g., as controlled by the tracking control portion 161) may each comprise a motor configured to achieve rotation around a respective rotation axis RA1 and RA2.

In various implementations, the rotation mechanism ROT1 may be located at or near the top of the support member 151 and may be utilized for rotating the main body portion 140 around the rotation axis RA1, and the rotation mechanism ROT2 may be utilized for rotating the main body portion 140 around the rotation axis RA2 (e.g., by rotating at least one of the base member 152 and/or the support member 151 around the rotation axis RA2). The angle sensor portion ASP is configured to sense one or more rotation angles A1, A2 (e.g., as illustrated in FIGS. 1A and 1B) of the rotator portion 150. In various implementations, the angle sensor portion ASP comprises a first angle sensor AS1 (e.g., comprising a rotary encoder) configured to sense a first rotation angle A1 around a first axis RA1 of the two axes of rotation, and a second angle sensor AS2 (e.g., comprising a rotary encoder) configured to sense a second rotation angle A2 around a second axis RA2 of the two axes of rotation (e.g., for sensing the rotations achieved by the rotation mechanisms ROT1 and ROT2, respectively).

As will be described in more detail below, the one or more rotation angles RA1, RA2 may be changed (e.g., by the rotator portion 150) to maintain an optical axis of reflected laser light at a center or other designated location of an optical sensor (e.g., of the main body portion 140). Such processes are performed as the position of the retroreflector portion RP is changed (e.g., such as when the retroreflector portion RP is moved to be disposed at different parts or positions of an object for measurements, etc.). Such processes thus result in the transmission direction of the transmitted laser light continuing to be adjusted to be directed at and thus track the retroreflector portion RP, and correspondingly enable an angular position of the retroreflector portion RP to be determined (e.g., in accordance with the transmission direction of the transmitted laser light, such as indicated by the angle sensors AS1 and AS2 of the angle sensor portion ASP and/or as otherwise determined by an angle determination portion 162 of FIG. 1A). In various implementations, it may be designated that in a state in which the main body portion 140 is in a flat orientation and the rotating mechanism 150 is in an origin state (e.g., with no rotation having yet occurred), the traveling direction (rightward direction in FIG. 1A) of the laser light emergent from the main body part 140 is set as a +Z-axis direction, and two axes perpendicular to this Z-axis are respectively set as an X-axis and a Y-axis (e.g., for which 3-dimensional positions of the retroreflector portion RP may be represented in terms of X, Y, Z coordinates in the indicated coordinate system). In various implementations, in the illustration of FIG. 1, an object W may represent a part of an object to be measured at which the retroreflector portion RP is disposed and/or may represent a moveable body that the retroreflector portion RP is mounted to (e.g., such as a moveable object, or as a part of a large industrial machine or other movable part for which the movements/positions are to be measured, etc.)

In various implementations, the control system portion 160 (or portions thereof) may be included as part of the laser and radar configuration LRC, or may be included as part(s) of a separate portion. The control system portion 160 includes a tracking control portion 161, an angle determination portion 162, a distance determination portion 163, a position determination portion 164, one or more processors 166, and a memory 167. In various implementations, the memory 167 is coupled to the one or more processors 166 and stores program instructions that when executed by the one or more processors 166 cause the one or more processors 166 to perform various functions/operations (e.g., such as for performing functions/operations of the tracking control portion 161, the angle determination portion 162, the distance determination portion 163, the position determination portion 164 and/or any other functions/operations as described herein).

Those skilled in the art will appreciate that the control system portion 160 (and/or any other control systems or control portions as described herein) may generally be implemented using any suitable computing system or device, including distributed or networked computing environments, and the like. Such computing systems or devices may include one or more general purpose or special purpose processors (e.g., non custom or custom devices) that execute software to perform the functions described herein. Software may be stored in memory, such as random access memory (RAM), read only memory (ROM), flash memory, or the like, or a combination of such components. Software may also be stored in one or more storage devices, such as optical based disks, flash memory devices, or any other type of non volatile storage medium for storing data. Software may include one or more program modules that include routines, programs, objects, components, data structures, and so on that perform particular tasks or implement particular abstract data types. In distributed computing environments, the functionality of the program modules may be combined or distributed across multiple computing systems or devices and accessed via service calls, either in a wired or wireless configuration.

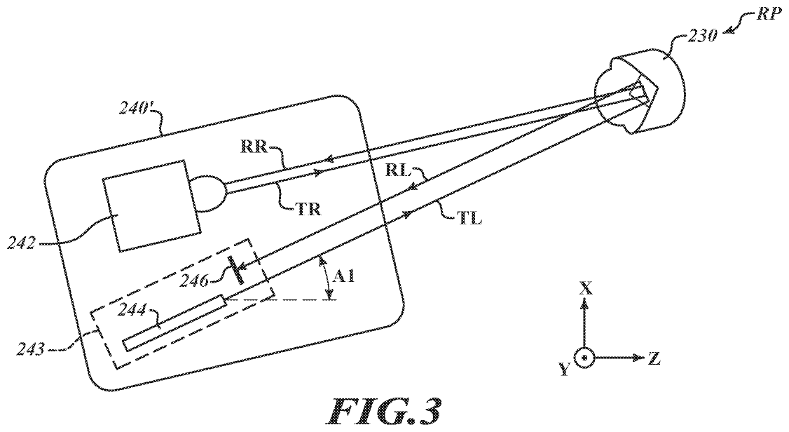

FIGS. 2A and 2B are diagrams illustrating a side view and a top view, respectively, of a main body portion 240 as directing laser light and radar signals toward a retroreflector portion RP comprising a retroreflector 230. It will be appreciated that certain numbered components 2XX or 2XX′ of FIGS. 2A, 2B, 3, etc. may correspond to and/or have similar operations as similarly numbered counterpart components 1XX of FIG. 1, and may be understood by analogy thereto, except as otherwise described below. This numbering scheme to indicate elements having analogous design and/or function (i.e., unless otherwise illustrated and/or described) is also applied to the remaining figures herein. It will also be appreciated that such similarly numbered components may represent certain more specific implementations (e.g., main body portions 240, 240′, 440, 440′, 440″, etc. of FIGS. 2A-6 may represent certain more specific implementations of the main body portion 140 as may be utilized in the metrology system of FIGS. 1A and 1B, etc.)

As illustrated in FIG. 2A, the main body portion 240 includes a radar portion 242 and a laser portion 243. In the implementation of FIGS. 2A and 2B, the main body portion 240 also includes reflective surfaces 248A and 248B for directing laser light (e.g., transmitted laser light TL) from the laser portion 243 to be parallel or coaxial with radar signals (e.g., a central axis of transmitted radar signals TR) from the radar portion 242. In various implementations, the reflective surfaces 248A and 248B comprise material that at least partially reflects laser light but is at least partially transmissive to radar signals. As one specific example, certain types of indium tin oxide coated glass may include such properties and be utilized for the reflective surfaces 248A and 248B. In various implementations, a configuration (not shown) may be utilized in which an end portion of the radar portion 242 (from which the radar signals are transmitted) is at least partially transparent to the laser light such the laser light may be directed through the end portion (e.g., in parallel or coaxial with a central axis of the transmitted radar signals, etc.).

As indicated in FIGS. 2A and 2B, the retroreflector portion RP comprises a retroreflector 230, and is configured to receive and reflect transmitted laser light TL (e.g., as transmitted from the laser portion 243), and to receive and reflect transmitted radar signals TR (e.g., as transmitted from the radar portion 242). In various implementations, the retroreflector portion RP is configured such that the reflected laser light RL is at least one of coaxial or parallel to the transmitted laser light TL that is received by the retroreflector portion RP. More specifically, the propagation direction of a beam of reflected laser light RL and the propagation direction of a beam of transmitted laser light TL are parallel to each other. In addition, the reflected laser light RL and the transmitted laser light TL may be centrosymmetric, that is, symmetric with respect to the center of the retroreflector 230 (i.e., point symmetry). Therefore, in a case where the transmitted laser light TL enters the retroreflector 230 at a certain position off the center, the path of the reflected laser light RL is shifted from the path of the transmitted laser light TL.

In various implementations, the retroreflector 230 may comprise a corner cube retroreflector, a cat-eye reflector, a recursive reflector, and/or may otherwise comprise one or more materials that are configured to reflect laser light. In various implementations, materials of the retroreflector 230 (or materials of the retroreflector portion RP) may be configured to reflect the transmitted radar signals TR (e.g., one or more materials may be included that reflect both the laser light and the radar signals, or different materials may be included that each are configured to reflect one of the laser light or the radar signals, for which the retroreflector portion RP in some implementations may include one or more materials or structures that are not part of the retroreflector 230, for reflecting the radar signals).

The radar portion 242 is configured to transmit the transmitted radar signals TR that are reflected by the retroreflector portion RP, and receive the reflected radar signals RR which enable a distance (e.g., distance D1 of FIG. 1A) to the retroreflector portion RP to be determined (e.g., in accordance with the operations of the distance determination portion 163 of FIG. 1A, etc.) The laser portion 243 comprises a laser 244 and an optical sensor 246. The laser 244 is configured to transmit the transmitted laser light TL that is reflected by the retroreflector portion RP. The optical sensor 246 is configured to receive the reflected laser light RL and to detect positional changes of an optical axis of the reflected laser light RL which occur as a result of positional changes of the retroreflector portion RP. In various implementations, the optical sensor 246 is an optical position sensor (e.g., in some implementations as comprising a two-axis photo sensitive detector (PSD), or a quadrant photo diode, etc.).

In the illustrated implementation, the laser portion 243 and the radar portion 242 are at different positions within the main body portion 240, for which the transmitted laser light TL and the transmitted radar signals TR are transmitted from different positions. In various implementations, distances and/or other positional relationships between the different positions may be known and/or utilized in calculations (e.g., for relating the determined rotation angles of the rotator portion to the determined distance for determining the overall 3-dimensional position corresponding to the position of the retroreflector portion). In various implementations, the laser light may be continuous wave (CW) laser light. In various implementations, the laser light is not frequency modulated. In various implementations, the radar signals are frequency modulated continuous wave (FMCW) radar signals.

As described above with respect to FIGS. 1A and 1B, the rotator portion 150 (FIG. 1A) is controlled to change the one or more rotation angles (e.g., corresponding to angles A1, A2 as illustrated in FIGS. 1A, 1B, 2A and 2B, which in some implementations may correspond to elevation and azimuthal angles, respectively). The one or more rotation angles are changed to maintain the optical axis of the reflected laser light RL at the center or other designated location of the optical sensor 246. As an example, in an implementation where the retroreflector 230 is a recursive reflector, when the retroreflector 230 is moved (e.g., toward a new measurement position), the position of the axis of the reflected laser light RL from the retroreflector 230 undergoes displacement. Accordingly, by controlling the rotating mechanism 150 on the basis of the position of the axis of the reflected laser light RL as detected by the optical sensor 246, the tracking control portion 161 is able to control the transmission direction of the transmitted laser light TL emergent from the main body portion 240 to thereby be directed at and track the retroreflector 230.

Such processes are performed as the position of the retroreflector portion RP is changed (e.g., such as when the retroreflector portion RP is moved to be disposed at different parts of an object for measuring the object, etc.). Such processes thus result in the transmission direction of the transmitted laser light TL continuing to be adjusted to be directed at and thus track the retroreflector portion RP, and correspondingly enable an angular position of the retroreflector portion RP to be determined (e.g., in accordance with the transmission direction of the transmitted laser light TL, such as indicated by the angle sensors AS1 and AS2 of the angle sensor portion ASP and/or as otherwise determined by the angle determination portion 162 of FIG. 1A).

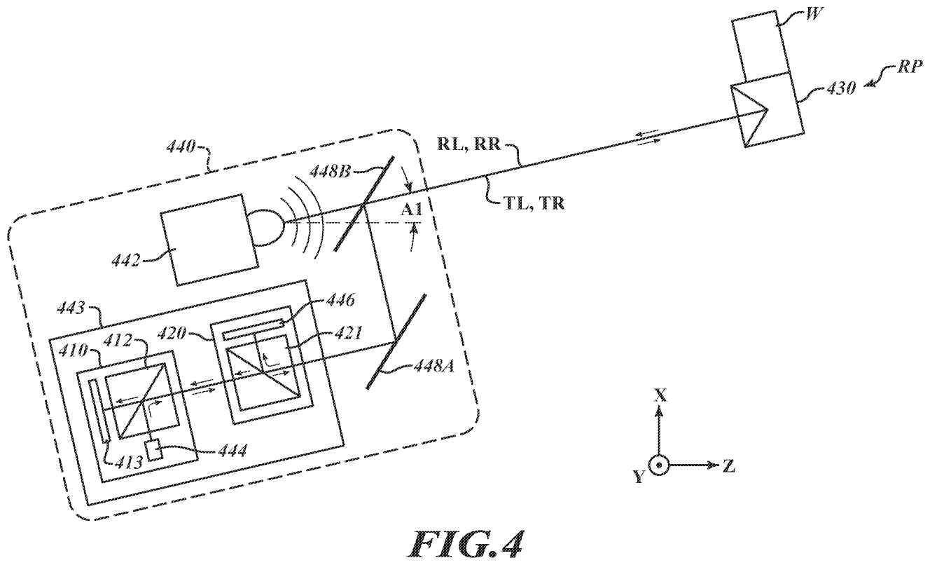

In various implementations, as described above, such processes may be performed by the control system portion 160 (e.g., including the memory 167 storing program instructions that when executed by the one or more processors 166 cause the one or more processors 166 to perform the designated functions, such as functions of the tracking control portion 161, angle determination portion 162, etc.) For example, as part of the functions of the tracking control portion 161, a signal may be received from the optical sensor 246 indicating that the optical axis of the reflected laser light RL (i.e., which intersects with the optical sensor 246) has moved from a central area or other designated area of the optical sensor 246 (e.g., as a result of movement of the retroreflector portion RP). The rotator portion 150 may then be controlled (e.g., by the tracking control portion 161) to change the transmission direction of the transmitted laser light TL (e.g., to be transmitted toward a central area of the retroreflector 230 of the retroreflector portion RP) so as to move the optical axis of the reflected laser light RL which intersects with the optical sensor 246 back to the central area of the optical sensor 246 (e.g., which thus results in the transmission direction of the transmitted laser light TL being directed toward and tracking with the current position of the retroreflector portion RP). Certain examples of such processes will also be described in more detail below with respect to FIG. 4.

As part of the functions of the angle determination portion 162, a first angular position of the retroreflector portion RP may be determined based at least in part on determined one or more rotation angles (e.g., rotation angles A1, A2) of the rotator portion 150 (e.g., as sensed and provided to the angle determination portion 162 by the angle sensors AS1 and AS2 of the angle sensing portion ASP). As part of the functions of the distance determination portion 163, a first distance to the retroreflector portion RP (e.g., such as the distance D1 of FIG. 1A) may be determined based at least in part on the reflected radar signals RR. Certain examples of such processes will also be described in more detail below with respect to FIG. 4. As part of the functions of the position determination portion 164, a first 3-dimensional position (e.g., including X, Y, Z or other coordinates of a designated 3-dimensional coordinate system) corresponding to a position of the retroreflector portion RP may be determined based at least in part on the determined angular position of the retroreflector portion RP and the determined distance to the retroreflector portion RP.

As one example set of operations for measuring/determining 3-dimensional coordinates of an object (e.g., which in some implementations may be a moveable object, or a relatively large object/workpiece, such as a constructed structure, or processing or industrial equipment, or a vehicle/vessel, etc.), the determined first 3-dimensional position may correspond to a first part or position of an object to be measured which the retroreflector portion RP is disposed at (e.g., placed proximate to, or in contact with, or coupled to, etc.). As the retroreflector portion RP is moved to be disposed at a second part or position of the object to be measured (e.g., as moved along a surface or to a different surface point on a object), as part of the functions of the tracking control portion 161, the rotator portion 150 is controlled to adjust the transmission direction of the transmitted laser light TL to be directed at and thus track the retroreflector portion RP, thus resulting in the transmitted laser light TL (e.g., and correspondingly the transmitted radar signals TR) being directed at the retroreflector portion RP when it is disposed at the second part or position of the object to be measured. As part of the functions of the angle determination portion 162, a second angular position of the retroreflector portion RP (e.g., while it is disposed at the second part or position of the object) may be determined based at least in part on determined one or more rotation angles of the rotator portion 150 (e.g., as sensed and provided to the angle determination portion 162 by the angle sensors AS1 and AS2 of the angle sensing portion ASP). As part of the functions of the distance determination portion 163, a second distance to the retroreflector portion RP (e.g., while it is disposed at the second part or position of the object) may be determined based at least in part on reflected radar signals RR. As part of the functions of the position determination portion 164, a second 3-dimensional position (e.g., while the retroreflector portion RP is disposed at the second part or position of the object) may be determined as corresponding to a position of the retroreflector portion RP based at least in part on the determined second angular position of the retroreflector portion RP and the determined second distance to the retroreflector portion RP.

In various implementations, it will be appreciated that the determined first 3-dimensional position and the determined second 3-dimensional position (e.g., each including X, Y, Z or other coordinates of a designated 3-dimensional coordinate system) may correspond to or otherwise indicate positions of surface points on the object being measured. In various implementations, such processes may be repeated to determine additional 3-dimensional positions, such as may correspond to determining a point cloud or other 3-dimensional representation or data of a surface and/or various parts of an object/workpiece that is being measured. In various implementations, a dimension of the object being measured may be determined based at least in part on a distance between a determined first 3-dimensional position and a determined second 3-dimensional position. Such processes may be repeated for determining multiple dimensions of an object being measured.

It will be appreciated that a metrology system utilizing a laser portion and radar portion as disclosed herein may have various advantages (e.g., over certain prior systems utilizing only laser or only radar technologies, etc.). It is noted that the operations of the laser portion may provide relatively higher accuracy angular position determinations/measurements utilizing certain relatively less expensive and more compact components (e.g., as compared to certain systems utilizing only radar technologies, which in some instances may produce relatively lower accuracy/lower resolution angular position determinations/measurements, such as due at least in part to the larger beam size/radar signal dispersion angles, etc.). In addition, the operations of the radar portion may provide relatively higher accuracy distance and resolution determinations utilizing certain relatively less expensive and more compact components (e.g., as compared to certain systems utilizing only laser technologies, which in some instances may produce relatively lower accuracy distance determinations and/or may require certain relatively expensive tunable/frequency modulated lasers for improving the accuracy of the distance determinations, etc.). In accordance with principles as disclosed herein, the utilization of the combination of the laser portion and the radar portion achieves certain desirable characteristics of both technologies in the disclosed metrology system.

FIG. 3 is a diagram illustrating a side view of a main body portion 240′ similar to the main body portion 240 of FIGS. 2A and 2B, except not including the reflective surfaces 248A and 248B. It will be appreciated that the elimination of the reflective surfaces 248A and 248B may be desirable in certain implementations where it is preferable to not have any components or other elements in the direct transmission and receiving paths of the radar portion 242 and/or laser portion 243 and/or is otherwise preferable to reduce the total number and expense of the included components, etc. In the main body portion 240′, the radar portion 242 and the laser portion 243 are illustrated as being orientated at an angle relative to one another.

In the illustrated configuration of FIG. 3, the laser portion 243 includes the laser 244 which transmits the laser light (e.g., having an optical axis) along a transmission direction which is not parallel or coaxial with the transmission direction (e.g., of a central axis) of the radar signals that are transmitted by the radar portion 242 toward the retroreflector portion RP. The directions of the reflected laser light and reflected radar signals as received by the optical sensor 246 and the radar portion 242, respectively, are correspondingly also not coaxial or parallel. For the processing of the distance of the retroreflector portion RP (e.g., as determined based at least in part on the operations of the radar portion 242) in relation to the angular position of the retroreflector portion RP (e.g., as determined based at least in part on the operations of the laser portion 243), for determining the overall 3-dimensional position of the retroreflector portion RP (e.g., within the designated 3-dimensional coordinate system), certain calculations/corrections may be made. In various implementations, such calculations/corrections may be based at least in part on the known geometric relationships (e.g., distances, orientations, etc.) between the radar portion 242 and the laser portion 243 (e.g., such as determinations made based on the trigonometric relationships for the components and the transmitted and received laser light and radar signals, etc.).

In the illustrated implementation, the angle A1 is determined based on the orientation of the laser portion 243 as transmitting the laser light to the retroreflector portion RP (e.g., in accordance with the similar operations of the laser portion 243 and rotator portion 150 as described above with respect to FIGS. 1A, 1B, 2A and 2B). It will be appreciated that in various implementations, the known geometric relationships between the radar portion 242 and the laser portion 243 may be utilized to determine an angular orientation of the radar portion 242 as transmitting the radar signals to the retroreflector portion RP. In various implementations, a distance of the retroreflector portion RP to the laser portion 243 may also or alternatively be determined (e.g., as based at least in part on the distance determined in accordance with the operations of the radar portion and in accordance with the known geometric/trigonometric relationships between the radar portion 242 and the laser portion 243). In various implementations, such calculations/determinations may be utilized for at least part of the determination of the 3-dimensional position of the retroreflector portion RP.

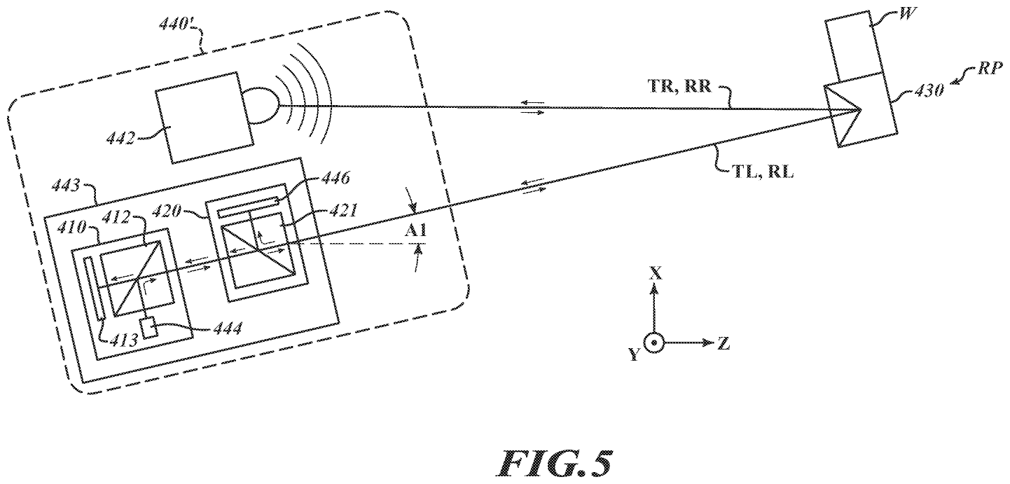

As will be described in more detail below (e.g., in relation to FIG. 5), in some implementations the radar portion 242 and the laser portion 243 may be oriented in parallel (e.g., with central axes of the transmitted laser light and radar signals being parallel), but for which the angular dispersion of the radar signals is sufficient to enable radar signals to be received and reflected by the retroreflector portion RP, to achieve operations similar to those described above. Such operations may be particularly effective in implementations where the retroreflector portion RP is at a sufficient distance from the main body portion (e.g., for which a relative angle between the paths of the reflected and received radar signals and laser light may be relatively small for relatively large distances of the retroreflector portion RP). As noted above, an angular orientation of the radar portion 242 as transmitting radar signals to the retroreflector portion RP, and/or a distance of the retroreflector portion RP to the laser portion 243, may also or alternatively be determined (e.g., as based at least in part on the known geometric relationships between the radar portion 242 and the laser portion 243, etc.).

FIG. 4 is a diagram illustrating a side view of a main body portion 440 including a radar portion 442 and a laser portion 443 with additional features and including reflective surfaces 448A and 448B for directing transmitted laser light TL from the laser portion 443 to be parallel or coaxial with transmitted radar signals TR (e.g., with a central axis of the transmitted radar signals TR) from the radar portion 442. For simplicity of the illustration of FIG. 4, the transmitted and reflected laser light TL and RL and the transmitted and reflected radar signals TR and RR are all represented by a single general travel path between the main body portion 440 and the retroreflector portion RP. Except as otherwise described below, the operations and certain components of the main body portion 440 will be understood to be similar to those of the main body portion 240 of FIGS. 2A and 2B.

As some examples of similarities, the locations and operations of the radar portion 442 and the reflective surfaces 448A and 448B will be understood to be similar to the locations and operations of the radar portion 242 and the reflective surfaces 248A and 248B of FIG. 2A. The location and operations of the retroreflector portion RP including the retroreflector 430 (and in relation to the object W) will be understood to be similar to the retroreflector portions RP including the retroreflectors 130 and 230 of FIGS. 1A and 2A (and in relation to the object W of FIG. 1A).

One difference of the main body portion 440 is that the laser portion 443 may include additional components that may also be utilized as part of a process for determining a distance to the retroreflector portion RP. For example, as illustrated in FIG. 4, in addition to a laser 444 (e.g., as may be similar to the laser 244 of FIG. 2A), the laser portion 443 may include a distance sensor portion 410 and a tracking sensor portion 420. The distance sensor portion 410 includes a beamsplitter 412 and an optical sensor 413 (e.g., and may include the laser 444 in some implementations), and the tracking sensor portion 420 includes a beamsplitter 421 and an optical sensor 446 (e.g., as may be similar to the optical sensor 246 of FIG. 2A).

In various implementations, the metrology system that includes the main body portion 440 may operate as follows. The beamsplitter 412 splits a beam of laser light emitted from the laser 444 into a beam of reference light (for simplicity not shown in the illustration), and a beam of transmitted laser light TL. In various implementations, a plane mirror (not shown in the illustration, but as may be located above the beamsplitter 412) reflects the reference light back to the beamsplitter 412 which reflects the reference light toward the optical sensor 413 (e.g., as may be utilized for interferometric operations as will be described in more detail below). The beam of transmitted laser light TL from the beamsplitter 444 passes through the beamsplitter 421 and is directed toward the reflective surfaces 448A and 448B for being directed toward the retroreflector portion RP. The reflected laser light RL as reflected from the retroreflector portion RP is backward light propagating back toward the main body portion 440. As described above, as part of the operations and potential movements of the retroreflector portion RP, the transmitted laser light TL sometimes enters the retroreflector 430 at a certain position off the center thereof (e.g., as may result due to a change in position/movement of the retroreflector portion RP). In such a case, the reflected laser light RL is reflected with an optical shift orthogonal to, or otherwise in relation to, the direction of the incidence of the transmitted laser light TL. Therefore, the path of the reflected laser light RL is shifted from the path of the transmitted laser light TL.

After being reflected by the reflective surfaces 448B and 448A back toward the beamsplitter 421, at least a portion of the reflected laser light RL is reflected/directed by the beamsplitter 421 toward the optical sensor 446. In accordance with the above described scenario, the reflected/directed laser light enters at a certain position off the center of the light reception plane of the optical sensor 446, depending on the amount of the shift. In one specific example implementation, the light reception plane of the optical sensor 446 may be sectioned into four blocks (e.g., including an upper left section, an upper right section, a lower left section, and a lower right section). In such a configuration, the optical sensor 446 may generate four received-light signals. The level of each of the four received-light signals depends on the amount of the reflected laser light that enters the corresponding one of the four sections of the light reception plane. In various implementations, the optical sensor 446 may output the four received-light signals to a tracking control portion (e.g., the tracking control portion 161 of FIG. 1A).

Referring back to FIG. 1A, the rotator portion 150 includes the rotation mechanism portion RMP that has two rotation axes RA1 and RA2 that are orthogonal to each other. Specifically, the rotation mechanism portion RMP includes a rotation mechanism ROT2 (e.g., an azimuthal angle rotation mechanism) and a rotation mechanism ROT2 (e.g., an elevation angle rotation mechanism). In various implementations, the rotation mechanism ROT2 changes the angle of azimuthal direction of the transmitted laser light TL, and the rotation mechanism ROT1 changes the angle of elevation of the transmitted laser light TL. The rotation mechanism ROT2 and the rotation mechanism ROT1 are controlled to change the direction of transmission of the transmitted laser light TL (e.g., changing the azimuthal angle of direction thereof and the angle of elevation thereof). In various implementations, an angle sensor AS1 and an angle sensor AS2 (e.g., comprising rotary encoders or other sensing mechanisms) are mounted on or otherwise configured to sense the angular/rotary orientations of the rotation mechanisms ROT1 and ROT2, respectively. The angle sensor AS2 (e.g., as mounted on the rotation mechanism ROT2) detects the rotation angle around the rotation axis RA2, which may correspond to the azimuthal angle of direction of the transmitted laser light TL, and outputs a detection result (e.g., indicating the sensed angle) to the tracking control portion 161 and/or the angle determination portion 162, etc. The angle sensor AS1 (e.g., as mounted on the rotation mechanism ROT1) detects the rotation angle around the rotation axis RA1, which may correspond to the angle of elevation of the transmitted laser light TL and outputs a detection result (e.g., indicating the sensed angle) to the tracking control portion 161 and/or the angle determination portion 162, etc. In various implementations, the point where the two rotation axes RA1 and RA2 intersect with each other may be taken as a reference point. In various implementations, a determined distance (e.g., as determined based on the operations of the laser portion 443 and/or the radar portion 442) may be in reference to a distance between the reference point and the retroreflector portion RP.

As described above, the tracking control portion 161 may be configured to control the rotator portion 150 on the basis of the received-light signal outputted from the optical sensor 446. The rotator portion 150 is controlled in such a manner that the shift amount of reflected laser light RL should fall within a predetermined range. With such control, the tracking control portion 161 causes the rotator portion 150 to keep track of the retroreflector portion RP. More specifically, as described above, in one example implementation the optical sensor 446 may output four received-light signals the level of each of which depends on the amount of reflected laser light that enters the corresponding one of four sections of a light reception plane. The tracking control portion 161 controls/drives the rotator portion 150 in such a way as to equalize the level of the received-light signals corresponding to the upper sections of the light reception plane with the level of the received-light signals corresponding to the lower sections of the light reception plane, thereby changing the angle A1 (e.g., the angle of elevation) of the transmitted laser light TL. In addition, the tracking control portion 161 controls/drives the rotator portion 150 in such a way as to equalize the level of the received-light signals corresponding to the left sections of the light reception plane with the level of the received-light signals corresponding to the right sections of the light reception plane, thereby changing the angle A2 (e.g., the azimuthal angle of direction) of the transmitted laser light TL. This control process may result in the transmission direction of the transmitted laser light TL continuing to be adjusted to be directed toward a central area of the retroreflector 430 of the retroreflector portion RP (e.g., as the retroreflector portion RP is moved to different locations where three-dimensional positions/coordinates are to be determined).

Returning to the reflected laser light RL that is directed by the reflective surface 448A toward the beamsplitter 421, at least a portion of the reflected laser light RL may pass through the beamsplitter 421 to be directed toward the beamsplitter 412. In the beamsplitter 412, the portion of the reflected laser light RL may be combined with the reference light (e.g., as described above), as resulting in interference light, which is received at the optical sensor 413. Upon receiving the interference light, the optical sensor 413 outputs a received-light signal (e.g., which is dependent on a change in a distance of the retroreflector portion RP), which in some implementations may be provided to the distance determination portion 163 of FIG. 1A. In various implementations, the distance determination portion 163 may determine an indicated distance to the retroreflector portion RP (e.g., a distance to the retroreflector portion RP from a reference point, such as described above), as based at least in part on the signal outputted from the optical sensor 413.

In various implementations, the indicated distance as determined in accordance with the above described operations of the laser portion 443 may be compared to (e.g., for verifying accuracy, etc.) or otherwise utilized in combination with (e.g., for increasing resolution/accuracy, etc.) an indicated distance as determined in accordance with the operations of the radar portion 442 (e.g., for which in various implementations such comparisons and/or combinations may be performed by or in accordance with the operations of the distance determination portion 163). In one implementation, the laser portion indicated distance may be an incremental distance which has very high accuracy, while the radar portion indicated distance may be an absolute distance, for which the resolution/accuracy may be improved by combining the determined high accuracy incremental distance (e.g., which may be referenced as a fine measurement) with the determined absolute distance (e.g., which may be referenced as a relatively coarser measurement). More specifically, in certain implementations, the determined absolute distance (e.g., of the radar portion) may be utilized to resolve any potential ambiguities for the determined incremental distance (e.g., of the laser portion), such as determining which overall wavelength of the laser portion the high accuracy incremental distance falls within, which may thereby indicate an absolute distance with higher accuracy and resolution.

In an implementation where the laser portion 443 is also being utilized as part of a process for determining a distance to the retroreflector portion RP, the extra distance that the laser light travels between and due to the reflective surfaces 448A and 448B may be known (e.g., due to the geometric relationships including the distance between the reflective surfaces 448A and 448B being known, etc.). Such known characteristics/distances may be included in the calculations for determining the distance to the retroreflector portion RP (e.g., such as for determining an indicated distance of the retroreflector portion RP in accordance with the operations of the laser portion 443, and as may be utilized in combination with or otherwise in relation to an indicated distance as determined in accordance with the operations of the radar portion 442, etc.).

In various implementations where a laser portion (e.g., laser portion 443, etc.) is utilized as part of a process for determining a distance (e.g., to the retroreflector portion RP), the laser portion 443 may transmit continuous wave (CW) laser light, and may utilize an interferometric arrangement and principles for determining a distance (e.g., as described above). Such distance determinations utilizing CW laser light and interferometric principles may have relatively high accuracy (e.g., in some implementations with an accuracy within 2 microns), but in some implementations may not provide an absolute measurement distance (i.e., may only indicate incremental distance measurements, such as within a wavelength of the laser light), for which if the path of the laser light is interrupted or if the retroreflector portion RP is moved more quickly than can be tracked (e.g., by the movements of the rotator portion 150), then the overall position within the range and correspondingly the total distance may become unknown if only the laser portion 443 was being utilized for determining the distance.

In certain alternative implementations, the laser portion 443 may transmit frequency modulated continuous wave (FMCW) laser light, and may utilize an interferometric arrangement and principles for determining a distance. Such distance determinations utilizing FMCW laser light and interferometric principles may provide an absolute measurement distance, but may have a relatively lower accuracy (e.g., in some implementations with an accuracy within 20 microns). In such a configuration, the frequency modulation may correspond to the frequency of the laser light being swept such that an interference pattern on the sensor 413 oscillates with a frequency proportional to the distance to the retroreflector portion RP. It will be appreciated that while such absolute measurement distances may be preferable for some applications, the lower accuracy achieved utilizing FMCW laser light may be undesirable for some implementations. In some cases, higher accuracy FMCW laser technologies may be utilized, but may have certain disadvantages (e.g., high cost etc., such as due to requiring a reference cavity or calibrated spectrometer system to monitor laser frequencies, etc.)

It will be appreciated that as an alternative to utilizing FMCW laser light for determining an absolute distance (e.g., to the retroreflector portion RP), as disclosed herein the operations of a radar portion (e.g., radar portion 242, 442, etc.) may be utilized (e.g., including utilizing FMCW radar signals and an interferometric arrangement and principles in some implementations) for determining a highly accurate absolute distance (e.g., to the retroreflector portion). In some implementations that utilize FMCW radar signals, the radar portion may sweep (e.g., frequency modulate) the transmitted frequency of the transmitted radar signals, and then may mix (e.g., in some implementations utilizing an interferometric configuration similar to that illustrated in the laser portion 443) the received reflected radar signals (e.g., the received radar waveform) with the transmitted radar signals (e.g., the transmitted radar waveform), for which the frequency difference between the two is dependent on the time-of-flight of the radar signals and therefor proportional to the distance to the retroreflector portion RP (e.g., for which the distance to the retroreflector portion RP may be determined based at least in part on the determined frequency difference). In various implementations, the distance D may be characterized by the following equation:

$$D = ( time of flight ) * c / 2 \qquad ( Eq . 1 )$$

where c=the speed of light, and the division by 2 is due to the round trip of the radar signals to and from the retroreflector portion RP (i.e., which thus travel a round trip distance equal to 2D). In various implementations, the signal analysis (e.g., for determining the frequency difference) may include analyzing the frequency content to determine the distance (e.g., including interpolating a peak location in a Fast Fourier Transform (FFT) power spectrum and/or utilizing other techniques such as determining a timing characteristic of the return peak of the reflected radar signals, etc.).

In various implementations, the laser (e.g., laser 244 or 444) may be a frequency-modulated continuous wave (FMCW) laser, or a continuous wave (CW) or quasi-CW laser, or an amplitude modulated (AM) laser, or a pulsed laser. In various implementations, the optical sensor (e.g., optical sensor 246 or 446) may be a time-resolved image sensor (e.g., a time-of-flight (TOF) sensor/camera, a single-photon avalanche diode (SPAD) array, etc.), which may be utilized for both detecting positional changes of an optical axis of the reflected laser light RL and for distance determination functions. In relation to the configuration of FIG. 4, such a time-resolved image sensor may thus be utilized to perform functions similar to those of both of the optical sensor 413 and the optical sensor 446 (e.g., for which in a configuration where the optical sensor 446 is a time-resolved image sensor, then in some implementations the optical sensor 413 may be eliminated).

More specifically, a time-resolved image sensor (e.g., as utilized as the optical sensor 246 in FIG. 2A or 3, or as the optical sensor 446 in FIG. 4, 5 or 6 with the optical sensor 413 eliminated in some implementations), may receive the reflected laser light RL and detect positional changes of an optical axis of the reflected laser light RL which occur as a result of positional changes of the retroreflector portion RP (e.g., similar or identical to the functions of the optical sensors 246 and 446 as described above), and may also be utilized to determine a distance of the retroreflector portion RP (e.g., based on time-of-flight or similar principles in accordance with the known operations of such time-of-flight sensors and/or SPAD arrays, etc.) In various implementations, an indicated distance as determined in accordance with such operations of a time-resolved image sensor of the laser portion 243 or 443 may be compared to (e.g., for verifying accuracy, etc.) or otherwise utilized in combination with (e.g., for increasing resolution/accuracy, etc.) an indicated distance as determined in accordance with the operations of the radar portion 242 or 442, such as described above or otherwise.

In an alternative implementation, the optical sensor 413 may be a time-resolved image sensor, such as utilized in combination with the laser being a pulsed laser or an AM laser, to determinate a relatively coarser measurement of the distance of the retroreflector portion RP (e.g., with an accuracy of a few millimeters) to aid/be utilized in combination with the distance of the retroreflector portion RP determined by the operations of the radar portion 442 (e.g., and for which the optical sensor 446 may continue to be included and utilized as described above for detecting positional changes of an optical axis of the reflected laser light RL). In such a configuration, the radar portion 442 may be enabled to sweep relatively faster and with fewer samples, and for which any ambiguity from range aliasing, etc. may be resolved with the utilization of the relatively coarser measurement of the distance of the retroreflector portion RP provided by the operation of the time-resolved image sensor 413 (e.g., as determined in accordance with time-of-flight principles, etc.).

FIG. 5 is a diagram illustrating a side view of a main body portion 440′ similar to the main body portion 440 of FIG. 4 except not including the reflective surfaces 448A and 448B. It will be appreciated that the elimination of the reflective surfaces 448A and 448B may be desirable in certain implementations where it is preferable to not have any components or other elements in the direct transmission and receiving paths of the radar portion 442 and/or laser portion 443 and/or is otherwise preferable to reduce the total number and expense of the included components, etc. In the main body portion 440′, the radar portion 442 and the laser portion 443 are illustrated as being orientated in parallel relative to one another (e.g., with central axes of the transmitted laser light and radar signals being parallel), but for which the angular dispersion of the radar signals is sufficient to enable radar signals to be received and reflected by the retroreflector portion RP, for which a path of transmitted and reflected radar signals to/from the retroreflector portion RP is illustrated as being at an angle relative to the path of the transmitted and reflected laser light.

The angular dispersion of the radar signals which enables radar signals to be received and reflected by the retroreflector portion RP (e.g., for which the radar portion 442 may have a specified angular dispersion for the transmitted radar signals) enables achievement of operations similar to those described above. Such operations may be particularly effective in implementations where the retroreflector portion RP is at a sufficient distance from the main body portion (e.g., for which a relative angle between the paths of the reflected and received radar signals and laser light may be relatively small for large distances of the retroreflector portion RP). As noted above, an angular orientation of the radar portion 442 as transmitting radar signals to the retroreflector portion RP, and/or a distance of the retroreflector portion RP to the laser portion 443, may also or alternatively be determined (e.g., as based at least in part on the known geometric relationships between the radar portion 442 and the laser portion 443).

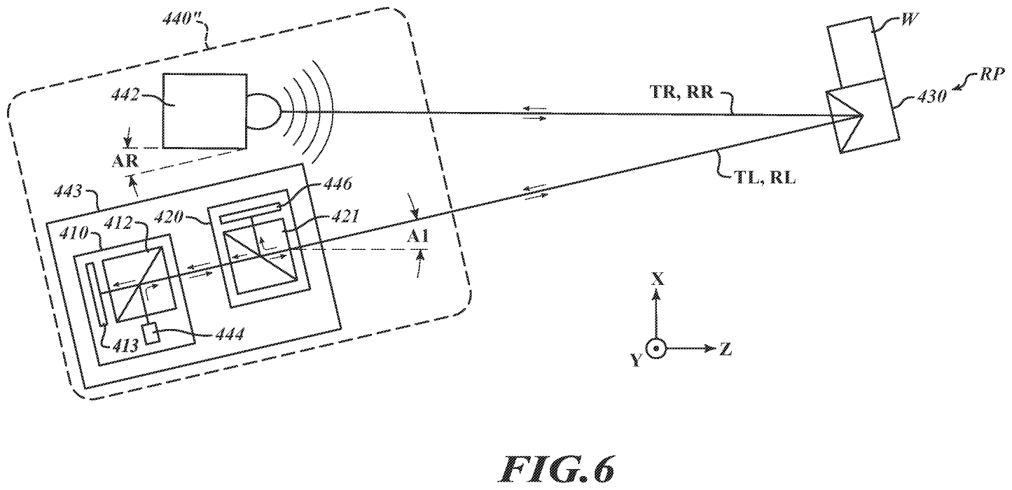

FIG. 6 is a diagram illustrating a side view of a main body portion 440″ similar to the main body portion 440′ of FIG. 5 except with the radar portion 442 oriented at an angle relative to the laser portion 443 (e.g., so as to have the radar portion 442 more directly pointed toward the retroreflector portion RP that the laser portion 443 is pointed at). In the illustrated configuration of FIG. 6, the laser portion 443 includes the laser 444 which transmits the laser light (e.g., having an optical axis) along a transmission direction which is not parallel or coaxial with the transmission direction (e.g., of a central axis) of the radar signals that are transmitted by the radar portion 442 toward the retroreflector portion RP. The directions of the reflected laser light and reflected radar signals as received by the optical sensor 446 and the radar portion 442, respectively, are correspondingly also not coaxial or parallel.

In various implementations, the angle at which the radar portion 442 is oriented in relation to the laser portion 443 may be based at least in part on an expected range or expected average range to the retroreflector portion RP. As a specific numerical example, in a configuration where the expected maximum range is approximately 25 meters, it may be desirable to have the central axes of the radar signals and the laser light intersect at 25 meters (e.g., rather than being parallel to one another). Alternatively, in such a configuration it may be considered desirable to have the intersection occur at an expected average distance of the retroreflector portion RP, such as at 15 meters. Similar principles are noted to apply with respect to the configuration of FIG. 3.

In relation to the illustrated configurations of FIGS. 5 and 6, for the processing of the distance of the retroreflector portion RP (e.g., as determined based at least in part on the operations of the radar portion 442) in relation to the angular position of the retroreflector portion RP (e.g., as determined based at least in part on the operations of the laser portion 443), for determining the overall 3-dimensional position of the retroreflector portion RP (e.g., within the designated 3-dimensional coordinate system), certain calculations/corrections may be made. In various implementations, such calculations/corrections may be based at least in part on the known geometric relationships (e.g., distances, orientations, etc.) between the radar portion 442 and the laser portion 443 (e.g., such as determinations made based on the known trigonometric relationships between the components and the transmitted and received laser light and radar signals, etc.).

In the illustrated implementations, an angle A1 is determined based on the orientation of the laser portion 443 as transmitting laser light to the retroreflector portion RP (e.g., in accordance with the similar operations of the laser portion 243 and rotator portion 150 as described above with respect to FIGS. 1A, 1B, 2A and 2B). It will be appreciated that in various implementations, the known geometric relationships between the radar portion 442 and the laser portion 443 may be utilized to determine an angular orientation of the radar portion 442 as transmitting radar signals to the retroreflector portion RP. In various implementations, a distance of the retroreflector portion RP to the laser portion 443 may also or alternatively be determined (e.g., as based at least in part on the distance determined in accordance with the operations of the radar portion and in accordance with the known geometric/trigonometric relationships between the radar portion 442 and the laser portion 443). In various implementations, such calculations/determinations may be utilized for the determination of the 3-dimensional position of the retroreflector portion RP.

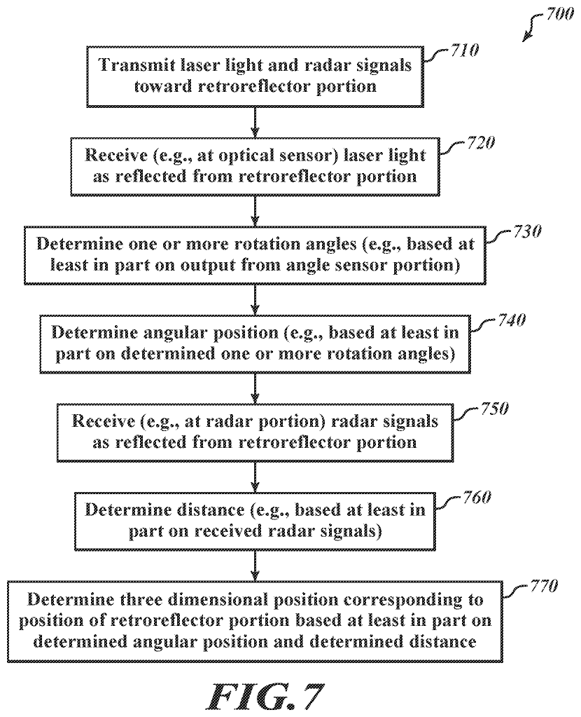

FIG. 7 is a flow diagram illustrating one exemplary implementation of a routine 700 for operating a metrology system including features as disclosed herein (e.g., a metrology system as described above with respect to FIGS. 1A-6). At a block 710, laser light and radar signals are transmitted (e.g., from a main body portion that includes a laser portion and a radar portion) toward a retroreflector portion. At a block 720, reflected laser light is received (e.g., at an optical sensor) as reflected from the retroreflector portion. At a block 730, one or more rotation angles (e.g., of a rotator portion) are determined (e.g., based at least in part on an output from an angle sensor portion). At a block 740, an angular position (e.g., of the retroreflector portion) is determined (e.g., based at least in part on the determined one or more rotation angles, such as of the rotator portion).

At a block 750, reflected radar signals are received (e.g., at the radar portion) as reflected from the retroreflector portion. At a block 760, a distance (e.g., to the retroreflector portion) is determined (e.g., based at least in part on the received reflected radar signals). At a block 770, a three dimensional position is determined that corresponds to the position of retroreflector portion based at least in part on the determined angular position (e.g., of the retroreflector portion) and the determined distance (e.g., to the retroreflector portion).

In various implementations, the determined 3-dimensional position may be a first 3-dimensional position that corresponds to a first part or position of an object to be measured which the retroreflector portion is disposed at. Then, after the retroreflector portion is moved to be disposed at a second part or position of the object to be measured, a second angular position of the retroreflector portion RP may be determined based at least in part on determined one or more rotation angles of the rotator portion. A second distance to the retroreflector portion RP (e.g., while the retroreflector portion RP is disposed at the second part or position of the object to be measured) may be determined based at least in part on reflected radar signals RR. A second 3-dimensional position corresponding to a position of the retroreflector portion RP (e.g., while the retroreflector portion RP is disposed at the second part or position of the object to be measured) may be determined based at least in part on the determined second angular position of the retroreflector portion RP and the determined second distance to the retroreflector portion RP. In various implementations, a dimension of the object to be measured may be determined based at least in part on a distance between the determined first 3-dimensional position and the determined second 3-dimensional position.

In various implementations, as part of the method, a signal may be received from the optical sensor that indicates that the optical axis of the reflected laser light (i.e., which intersects with the optical sensor) has moved from a central area of the optical sensor (e.g., as a result of movement of the retroreflector portion, such as for moving to be disposed at the second part or position of the object to be measured). In response to the received signal, the rotator portion may be controlled to change the transmission direction of the laser light so as to move the optical axis of the reflected laser light which intersects with the optical sensor back to the central area of the optical sensor.

In various implementations, the main body portion (e.g., with the laser portion and the radar portion) may be configured such that the transmitted laser light and the transmitted radar signals are transmitted from different positions. In various implementations, distances and/or other positional relationships between the different positions may be known and/or utilized in calculations (e.g., for relating the determined rotation angles of the rotator portion to the determined distance for determining the overall 3-dimensional position corresponding to the position of the retroreflector portion).

In various implementations, a laser and radar configuration is provided for use with a retroreflector portion comprising a retroreflector as part of a metrology system. The laser and radar configuration comprises the main body portion and the rotator portion. The main body portion comprises the laser portion and the radar portion. The rotator portion is configured to rotate the main body portion to change a transmission direction of the laser light and the radar signals (e.g., to be directed toward the retroreflector portion). In various implementations, the main body portion may include one or more reflective surfaces in the path of the laser light which are configured to direct the laser light to be coaxial with the radar signals (e.g., with a central axis of the radar signals).

It will be appreciated that the principles disclosed and claimed herein may be readily and desirably combined with various features disclosed in the incorporated references. The various implementations described above can be combined to provide further implementations. All of the U.S. patents and U.S. patent applications referred to in this specification are incorporated herein by reference, in their entirety. Aspects of the implementations can be modified, if necessary to employ concepts of the various patents and applications to provide yet further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled.

1. A metrology system, comprising:
a retroreflector portion comprising a retroreflector, wherein the retroreflector portion is configured to:
receive and reflect transmitted laser light as transmitted from a laser portion; and
receive and reflect transmitted radar signals as transmitted from a radar portion;
a laser and radar configuration, comprising:
a main body portion, comprising:
a laser portion comprising:
a laser configured to transmit the laser light that is reflected by the retroreflector portion;
an optical sensor configured to receive the reflected laser light and to detect positional changes of an optical axis of the reflected laser light which occur as a result of positional changes of the retroreflector portion; and
a radar portion configured to:
transmit the radar signals that are reflected by the retroreflector portion; and
receive the reflected radar signals which enable a distance to the retroreflector portion to be determined; and
a rotator portion configured to rotate the main body portion to change a transmission direction of the laser light and the radar signals, the rotator portion comprising an angle sensor portion configured to sense one or more rotation angles of the rotator portion.

2. The metrology system of claim 1, further comprising:
one or more processors; and
a memory coupled to the one or more processors and storing program instructions that when executed by the one or more processors cause the one or more processors to at least:
receive a signal from the optical sensor indicating that the optical axis of the reflected laser light has moved from a central area of the optical sensor as a result of movement of the retroreflector portion; and
control the rotator portion to change the transmission direction of the laser light so as to move the optical axis of the reflected laser light which intersects with the optical sensor back to the central area of the optical sensor.

3. The metrology system of claim 2, wherein the program instructions when executed by the one or more processors further cause the one or more processors to:
determine a first angular position of the retroreflector portion based at least in part on the determined one or more rotation angles of the rotator portion; and
determine a first distance to the retroreflector portion based at least in part on the reflected radar signals.

4. The metrology system of claim 3, wherein the program instructions when executed by the one or more processors further cause the one or more processors to determine a first 3-dimensional position corresponding to a position of the retroreflector portion based at least in part on the determined angular position of the retroreflector portion and the determined distance to the retroreflector portion.

5. The metrology system of claim 4, wherein:
the determined first 3-dimensional position corresponds to a first part or position of an object to be measured which the retroreflector portion is disposed at;
after the retroreflector portion is moved to be disposed at a second part or position of the object to be measured, the program instructions when executed by the one or more processors further cause the one or more processors to:
determine a second angular position of the retroreflector portion based at least in part on determined one or more rotation angles of the rotator portion; and
determine a second distance to the retroreflector portion based at least in part on reflected radar signals; and
determine a second 3-dimensional position corresponding to a position of the retroreflector portion based at least in part on the determined second angular position of the retroreflector portion and the determined second distance to the retroreflector portion.

6. The metrology system of claim 5, wherein the program instructions when executed by the one or more processors further cause the one or more processors to determine a dimension of the object to be measured based at least in part on a distance between the determined first 3-dimensional position and the determined second 3-dimensional position.

7. The metrology system of claim 1, wherein the retroreflector portion is configured such that the reflected laser light is at least one of coaxial or parallel to the transmitted laser light that is received by the retroreflector portion.

8. The metrology system of claim 1, wherein the laser is a frequency-modulated continuous wave (FMCW) laser.

9. The metrology system of claim 1, wherein the laser is a continuous wave (CW) laser or a quasi-CW laser, but is not frequency modulated.

10. The metrology system of claim 1, wherein the laser is at least one of an amplitude modulated (AM) laser or a pulsed laser.

11. The metrology system of claim 1, wherein the optical sensor is a time-resolved image sensor.

12. The metrology system of claim 1, wherein the optical sensor is an optical position sensor that comprises at least one of a two-axis photo sensitive detector (PSD) or a quadrant photo diode.

13. The metrology system of claim 1, wherein the radar signals are frequency modulated continuous wave (FMCW) radar signals.

14. The metrology system of claim 1, further comprising one or more reflective surfaces in the path of the laser light which are configured to direct the laser light to be coaxial with the radar signals.

15. The metrology system of claim 1, wherein the laser portion and the radar portion are at different positions within the main body portion for which the transmitted laser light and the transmitted radar signals are transmitted from different positions.

16. The metrology system of claim 1, wherein:
the rotator portion comprises a rotation mechanism portion having two axes of rotation and configured to independently rotate along the two axes to change the transmission direction of the laser light and the radar signals; and
the angle sensor portion comprises:
a first angle sensor configured to sense a first rotation angle around a first axis of the two axes of rotation; and
a second angle sensor configured to sense a second rotation angle around a second axis of the two axes of rotation.

17. A method for operating a metrology system,
the metrology system comprising:
a retroreflector portion comprising a retroreflector, wherein the retroreflector portion receives and reflects transmitted laser light as transmitted from a laser portion, and receives and reflects transmitted radar signals as transmitted from a radar portion;
a laser and radar configuration, comprising:
a main body portion, comprising:
a laser portion comprising:
a laser that transmits the laser light that is reflected by the retroreflector portion; and
an optical sensor that receives the reflected laser light and detects positional changes of an optical axis of the reflected laser light which occur as a result of positional changes of the retroreflector portion; and
a radar portion that transmits the radar signals and receives the reflected radar signals;
a rotator portion configured to rotate the main body portion to change a transmission direction of the transmitted laser light and the transmitted radar signals, the rotator portion comprising an angle sensor portion configured to sense one or more rotation angles of the rotator portion;
the method comprising:
determining a first angular position of the retroreflector portion based at least in part on the determined one or more rotation angles of the rotator portion; and
determining a first distance to the retroreflector portion based at least in part on the reflected radar signals; and
determining a first 3-dimensional position corresponding to a position of the retroreflector portion based at least in part on the determined angular position of the retroreflector portion and the determined distance to the retroreflector portion.

18. The method of claim 17, further comprising:
receiving a signal from the optical sensor indicating that the optical axis of the reflected laser light has moved from a central area of the optical sensor as a result of movement of the retroreflector portion; and
controlling the rotator portion to change the transmission direction of the laser light so as to move the optical axis of the reflected laser light which intersects with the optical sensor back to the central area of the optical sensor.

19. The method claim 17, wherein:
the determined first 3-dimensional position corresponds to a first part or position of an object to be measured which the retroreflector portion is disposed at; and
the method further comprises:
after the retroreflector portion is moved to be disposed at a second part or position of the object to be measured, determining a second angular position of the retroreflector portion based at least in part on determined one or more rotation angles of the rotator portion;
determining a second distance to the retroreflector portion based at least in part on reflected radar signals; and
determining a second 3-dimensional position corresponding to a position of the retroreflector portion based at least in part on the determined second angular position of the retroreflector portion and the determined second distance to the retroreflector portion.

20. The method of claim 19, further comprising determining a dimension of the object to be measured based at least in part on a distance between the determined first 3-dimensional position and the determined second 3-dimensional position.

21. The method of claim 17, wherein the transmitted laser light and the transmitted radar signals are transmitted from different positions.

22. A laser and radar configuration for use with a retroreflector portion comprising a retroreflector as part of a metrology system, the laser and radar configuration comprising:
a main body portion comprising:
a laser portion comprising:
a laser configured to transmit laser light that is reflected by the retroreflector portion; and
an optical sensor configured to receive the reflected laser light and to detect positional changes of an optical axis of the reflected laser light which occur as a result of positional changes of the retroreflector portion; and
a radar portion configured to:
transmit the radar signals that are reflected by the retroreflector portion; and
receive the reflected radar signals which enable a distance to the retroreflector portion to be determined; and
a rotator portion configured to rotate the main body portion to change a transmission direction of the laser light and the radar signals, the rotator portion comprising an angle sensor portion configured to sense one or more rotation angles of the rotator portion.

23. The laser and radar configuration of claim 22, further comprising:
one or more processors; and
a memory coupled to the one or more processors and storing program instructions that when executed by the one or more processors cause the one or more processors to at least:
receive a signal from the optical sensor indicating that the optical axis of the reflected laser light has moved from a central area of the optical sensor as a result of movement of the retroreflector portion; and
control the rotator portion to change the transmission direction of the laser light so as to move the optical axis of the reflected laser light which intersects with the optical sensor back to the central area of the optical sensor.
